(19) United States
(12) Patent Application Publication
(10) Pub. No.: US 2026/0276915 A1
(43) Pub. Date: Sep. 17, 2026

(54) PLUGGABLE CHIP INTERPOSER FOR PHOTONIC CHIP ALIGNMENT

(71) Applicant: University of Rochester, Rochester, NY (US)

(72) Inventors: Jaime Cardenas Gonzalez, Rochester, NY (US); Sushant Kumar, Rochester, NY (US)

(73) Assignee: University of Rochester, Rochester, NY (US)

(21) Appl. No.: 19/473,189

(22) PCT Filed: Apr. 8, 2024
(86) PCT No.: PCT/US2024/023547

§ 371 Date: Oct. 7, 2025

Related U.S. Application Data
(60) Provisional application No. 63/457,881, filed on Apr. 7, 2023.

(51) Int. Cl. G02B 6/42; G02B 6/12; G02B 6/122

(52) U.S. Cl. CPC G02B 6/423; G02B 6/1228; G02B 6/4236; G02B 6/4257; G02B 6/4278; G02B 2006/12176

(57) ABSTRACT

A system for aligning chips, such as chips with photonic devices, includes a first device, such as a laser, on a first chip, a second device, such as a mode converter, on a second chip, and a substrate. A first pattern is formed in the first chip, and a second pattern is formed in the second chip. A third pattern is formed in the substrate and arranged to complement the first pattern and the second pattern so that the first device is aligned (e.g., optically) with the second device while the first chip and the second chip are mounted on the substrate.

### CROSS-REFERENCE TO RELATED APPLICATIONS

This application claims priority to U.S. Provisional Patent Application No. 63/457,881 filed on Apr. 7, 2023, the disclosure of which is incorporated by reference in its entirety for all purposes.

### STATEMENT REGARDING FEDERALLY SPONSORED RESEARCH OR DEVELOPMENT

This invention was made with government support under Contract IIP-2140871 awarded by the National Science Foundation. The government has certain rights in the invention.

### BACKGROUND

The present disclosure relates to a photonic system, and without limitation to optical coupling to a photonic chip. An integrated circuit is chip containing electronic components that form a functional circuit, such as those embedded inside a smartphone, computer, or other electronic devices. A photonic integrated circuit (PIC) is a chip that contains photonic components, which are components that work with light (photons). A photonic system may include multiple photonic chips that contain optical components such as waveguides, lasers, polarizers, and phase shifters.

### BRIEF SUMMARY

In some embodiments, a system for aligning photonic devices comprises a first chip comprising a first substrate coupled with a first optical device, a first pattern formed within the first substrate, wherein: the first optical device comprises a laser, and the first pattern is a three-dimensional pattern comprising a wall at least partially forming a first recess; a second chip comprising a second substrate coupled with a second optical device, a second pattern formed within the second substrate, wherein: the second optical device comprises a waveguide, the second pattern is a three-dimensional pattern comprising a wall at least partially forming a second recess, and an opening of the second recess has the same dimensions as an opening of the first recess; and a third substrate, a third pattern formed within the third substrate, wherein: the third pattern is a three-dimensional pattern, the third pattern comprises a first pillar and a second pillar, the third pattern is arranged to complement the first pattern and the second pattern so the first pillar fits in the first recess and the second pillar fits in the second recess so that the first optical device is optically aligned with the second optical device while the first chip and the second chip are mounted on the third substrate, and there is a gap between the first substrate and the second substrate, while the first substrate and the second substrate are mounted on the third substrate.

In some configurations, a system for aligning photonic devices comprises a first chip comprising a first substrate coupled with a first optical device, a first pattern formed within the first substrate, wherein the first pattern is a three-dimensional pattern; a second chip comprising a second substrate coupled with a second optical device, a second pattern formed within the second substrate, wherein the second pattern is a three-dimensional pattern; and/or a third substrate, a third pattern formed within the third substrate, wherein the third pattern is a three-dimensional pattern and arranged to complement the first pattern and the second pattern so that the first optical device is optically aligned with the second optical device while the first chip and the second chip are mounted on the third substrate. In some embodiments, the first pattern and the second pattern are configured to interlock with the third pattern; the first substrate, the second substrate, and the third substrate are formed from silicon (e.g., single-crystal silicon); an alignment of the first optical device and the first optical device is in a dimension orthogonal to a height of the third substrate so that the first optical device is butt coupled with the second optical device; the first chip, the second chip, and the third substrate contain alignment structures which are substantially in a height dimension of the first substrate, the second substrate, and the third substrate; the first chip, the second chip, and the third substrate contain alignment structures that are substantially perpendicular to a direction of light propagation; the first pattern comprises a cylindrical shape and the third pattern comprises a wall forming a circular recess; the first substrate is non-contiguous with the second substrate while mounted on the third substrate; the first optical device is a laser, and the second optical device is a waveguide; the second pattern is the same as the first pattern; and/or the waveguide comprises a nitride taper formed within the waveguide.

In some configurations, a method for aligning photonic devices comprises obtaining a first chip, wherein the first chip comprises a first substrate coupled with a first optical device, a first pattern formed within the first substrate, wherein the first pattern is a three-dimensional pattern; obtaining a second chip, wherein the second chip comprises a second substrate coupled with a second optical device, a second pattern formed within the second substrate, wherein the second pattern is a three-dimensional pattern; obtaining a third substrate, a third pattern formed within the third substrate, wherein the third pattern is a three-dimensional pattern; and/or mounting the first chip and the second chip on a third substrate, wherein the third pattern is arranged to complement the first pattern and the second pattern so that the first optical device is optically aligned with the second optical device while the first chip and the second chip are mounted on the third substrate. In some embodiments, the method further comprises measuring an optical alignment between the first optical device and the second optical device; the method further comprises modifying an etching of the first substrate, the second substrate, and/or the third substrate based on the optical alignment measured; the first pattern and the second pattern are configured to interlock with the third pattern; an alignment of the first optical device and the second optical device is in a dimension substantially perpendicular with a height of the third substrate; the first substrate, the second substrate, and the third substrate contain alignment structures which are substantially parallel to a height of the third substrate; the first substrate is non-contiguous with the second substrate while mounted on the third substrate; and/or the first optical device is a laser, and the second optical device is a waveguide.

In some configurations, a system comprises a first chip comprising a first device, a first pattern formed within the first chip; a second chip comprising a second device, a second pattern formed within the second chip; and/or a substrate, a third pattern formed within the substrate, wherein the third pattern is arranged to complement the first pattern and/or the second pattern, and the first device is aligned with the second device. In some embodiments, an electrical contact is in the first pattern of the first chip; a conductive layer is in the substrate in the third pattern, arranged to electrically connect with the electrical contact in the first pattern while the first chip is mounted to the substrate; the electrical contact is in a recess of the first pattern; the conductive layer is on a post of the third pattern; the first chip is optically aligned horizontally with the second chip; vertical is defined in a direction of a height of the substrate; the first chip mounted on top of the second chip; the second chip mounted on the substrate, so that the second chip is between the substrate and the first chip while the second chip is mounted on the substrate; the first chip is optically aligned vertically with the second chip; and/or the first pattern is formed in the first optical device.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures.

FIG. 1 is a view illustrating an embodiment of a photonic system for aligning optical components.

FIG. 2A illustrates an embodiment of a pattern in a first substrate and/or a second substrate.

FIG. 2B illustrates an embodiment of a pattern in a third substrate.

FIG. 3 is a flowchart of an embodiment of a process for aligning optical devices.

FIG. 4 illustrates an embodiment of electrical connections with a pluggable chip interposer.

FIG. 5 illustrates an embodiment of multiple vertical chip integration.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

The present disclosure relates to a photonic system, and more particularly and without limitation relates to a photonic system that includes multiple photonic chip components that are couplable through a pluggable pattern enabling ready replacement of individual chip components in case of failure.

Photonic chips have used V-shaped grooves (sometimes referred to a V-grooves) for passive alignment of fibers, but this involves a creation of one or more V-grooves on the chip. Using V-grooves in a chip can be non-pluggable and, in case of failure of the fiber-chip connection, a whole device can be rendered useless. Similarly, chip to laser connections via hybrid integration and photonic wire-bonding have been demonstrated in the recent years. A laser chip, being an active part of the circuit, is prone to failure, which again can render the whole device useless in the event that one component on a photonic chip fails.

In some embodiments, a pluggable type structure designed for precise alignment of chips or wafers is used to achieve high accuracy (e.g., sub 2 micron (μm) accuracy). This high level of precision is particularly significant in the field of photonics, where alignment accuracy is important for performance of devices (e.g., for Silicon Oxide mode converters). Some configurations allow for versatility to use a wide variety of optical modes which match precisely at a chip's edge. Empirical data has confirmed that some configurations achieve a coupling tolerance within a −1 dB (equating to a 20% deviation in coupling) for a tolerance window of 2.5 microns (e.g., using an oxide mode converter). Some configurations provide precision that allows for the potential of the pluggable type structure to enhance reliability and/or performance of photonic devices.

Some configurations allow for patterning a pattern (e.g., pattern one half of the pluggable type structure) on a silicon (or other material) substrate and use it as interposer for a first chip (e.g., a light source such as a laser) and a second chip (e.g., a fiber assembly or waveguide). The first chip and second chip may each have a complementary pattern which is pluggable into a pattern formed on a third substrate. This allows for quick assembly of the photonic system and easy swapping of individual system components in case of failure. This makes the system truly pluggable and resilient to component failure since a user can quickly replace a laser chip and/or a fiber connection, which are two common points of failure in an electro-optic system.

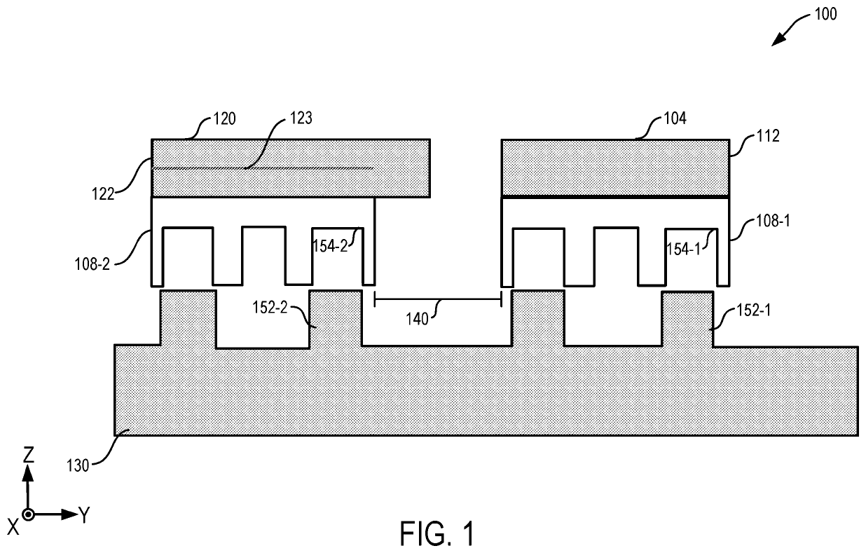

Referring to FIG. 1, an embodiment of a photonic system 100 for aligning photonic components is shown. The photonic system 100 comprises a first chip 104. The first chip 104 comprises a first substrate 108-1 and a first optical device 112 (e.g., a laser or light-emitting diode) coupled with the first substrate 108-1.

The photonic system 100 comprises a second chip 120. The second chip 120 comprises a second substrate 108-2 and a second optical device 122 (e.g., a waveguide) coupled with the second substrate 108-2. A first pattern in formed in the first substrate 108-1 and a second pattern is formed in the second substrate 108-2. In some embodiments, the second pattern is the same as the first pattern. The second optical device 122 can be a mode converter. In some examples, a nitride taper 123 may be incorporated within the second optical device 122. The second optical device 122 may be configured to receive an optical signal transmitted or output from the first optical device 112.

The photonic system 100 comprises a third substrate 130 (e.g., made of crystalline semiconductor, such as silicon; glass, polymer, etc.). A third pattern is formed within the third substrate. The third pattern is arranged to complement the first pattern and the second pattern so that the first optical device 112 is optically aligned with the second optical device 122, while the first chip 104 and the second chip 120 are mounted on the third substrate 130. There is a gap 140 between the first substrate 108-1 and the second substrate 108-2 while the first substrate 108-1 and the second substrate 108-2 are mounted on the third substrate 130. In some embodiments, the first substrate 108-1, the second substrate 108-2, and/or the third substrate 130 serve as an interposer (e.g., with electrical interconnects).

In some embodiments, an optical device is coupled with a substrate by soldering, mechanical, adhesives, bonding, deposition, and/or epitaxial growth. For example, quantum wells and/or buffer layers are grown on a III/V substrate, or a laser chip is bonded to a silicon substrate, to form the first chip 104. In another example, a silicon dioxide layer is deposited on a silicon substrate and a mode converter is formed in the silicon dioxide layer, to form the second chip 120. Though a laser and mode converter are provided as examples, a person skilled in the art will understand that different optical components can be aligned using similar techniques. Some examples of optical devices include edge emitting lasers, distributed feedback lasers, quantum cascade lasers, mode converters, meta lenses, micro lenses, and waveguides (e.g., optical fiber, semiconductor, silicon, III-V, single-crystal core, polycrystalline, amorphous, lithium niobate, silicon carbide, diamond, glass, polymer). In some configurations, coupling between different chips is for heterogeneous integration. In some configurations, a mode converter is considered part of a waveguide because the mode converter guides confined light in a higher refractive index core surrounded by a lower refractive index cladding.

In FIG. 1, a cartesian coordinate system with three orthogonal dimensions (x, y, z) is shown. The x axis runs into and out of the page, the y axis is horizontal, and the z axis is vertical. The third substrate 130 is oriented so that a height of the third substrate 130 is oriented in a direction of the z axis. The first optical device 112 is optically aligned with the second optical device 122 in a direction substantially perpendicular (e.g., 90 degrees plus or minus 1, 2, 3, or 5 degrees) with respect to a height of the third substrate 130. For example, the first optical device 112 is optically aligned horizontally (e.g., along the y axis) with the second optical device 122; in a direction in (or parallel with) the x/y plane.

The third substrate 130 may be arranged to form a base on which the first chip 104 and the second chip 120 may be placed and secured by frictional and/or gravitational forces. In some configurations, metal interfaces are soldered, which can provide electric connections (e.g., via wire bonding). The first substrate 108-1, the second substrate 108-2, and/or the third substrate 130 may be formed from a silicon wafer. However, a person of skill in the art will appreciate that other materials or a mix of materials may be used.

The first pattern formed in the first substrate 108-1, the second pattern formed in the second substrate 108-2, and the third pattern formed in the third substrate 130 are three dimensional patterns (e.g., being etched into a height of a substrate). The first pattern and second pattern are formed and dimensioned to interlock with the third pattern. For example, raised pillars 152 in the third substrate 130 and walls forming a recess 154 (e.g., hole) in the substrate 108, or other alignment structures (e.g., passive alignment structures), are used. The patterns are three dimensional because they are used to optically align optical devices in three dimensions (e.g., in x, y, and z).

Patterns may be complementary or partly complementary to one another to allow for interlocking between the patterns. For example, the patterns may establish a friction or tolerance fit coupling between the components. As illustrated in FIG. 1, the patterns are substantially etched in a “z” axis to enable alignment between the first optical device 112 and the second optical device 122 by adjusting the depth or height of a pattern in the z axis. For example, heights of pillars 152 can be used for z-height registration. Etching or formation in the x/y plane aligns devices along the x and y axes and can increase or decrease surface area for a frictional or gravitation fit, which may avoid the use of a bonding agent with respect to the third substrate 130.

The pluggable or relative patterns between the components, which may be complementary, allow for a frictional or tolerance fit coupling between the components. The pluggable or complementary aspect of the patterns with respect to one another enables the ready connecting of the first substrate 108-1 and the second substrate 108-2 with respect to the third substrate 130. This further allows for selective release of the first chip 104 and/or the second chip 120 from the third substrate 130, thereby establishing a modular system for effecting coupling and decoupling of optical components with respect to the third substrate 130. The pluggable relation enables quick assembly of the photonic system and easy swapping of individual system components in case of failure.

After assembly, the first substrate 108-1 is between the first optical device 112 and the third substrate 130; the second substrate 108-2 is between the second optical device 122 and the third substrate 130.

The first pattern in the first substrate 108-1, and/or the second pattern in the second substrate 108-2, may be formed with a fixed dimension and tolerance in the “z” direction to complement pillar-shape patterns formed in the third substrate 130. In some configurations, the first pattern and/or the second pattern may be modified based on manufacturing tolerances and/or alignment errors in the first optical device 112 or the second optical device 122 to ensure that optical devices are optically aligned while the first chip 104 and the second chip 120 are placed on the third substrate 130. In some configurations, no adhesive or bonding material is used to secure the first chip 104 and/or the second chip 120 to the third substrate 130. In some embodiments, chips are bonded to the third substrate 130.

In the example shown in FIG. 1, the third pattern comprises a first pillar 152-1 and a second pillar 152-2. The third pattern is arranged to complement the first pattern and the second pattern so the first pillar 152-1 fits in a first recess 154-1 of the first substrate 108-1, and the second pillar 152-2 fits in a second recess 154-2 of the second substrate 108-2.

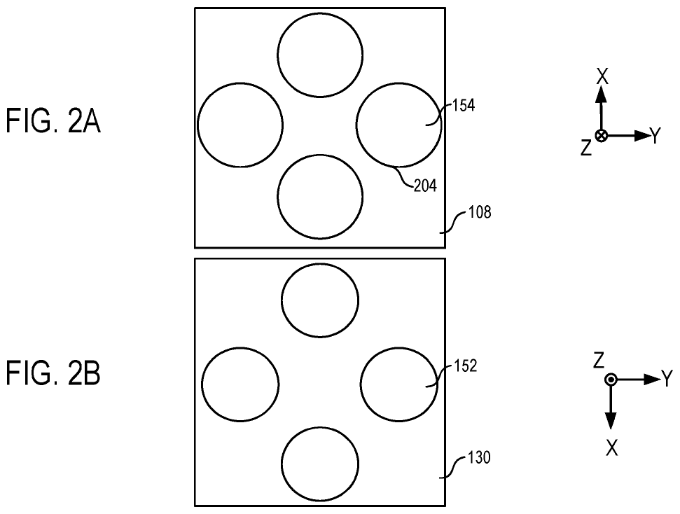

FIGS. 2A and 2B provide additional views of components of the photonic system 100 of FIG. 1. FIG. 2A illustrates an embodiment of the first pattern and/or the second pattern in the substrate 108 (e.g., in the first substrate 108-1 and/or the second substrate 108-2 in FIG. 1). The view in FIG. 2A is in the positive z direction (z is pointing into the page). The first pattern comprises a wall 204 at least partially forming the recess 154. If the recess was a polygon shape, then the wall 204 would be one of a plurality of walls forming the recess 154. The embodiment of the first pattern shown in FIG. 2A is just a portion of the first pattern because recesses are repeated in the x and/or y dimensions.

FIG. 2B illustrates an embodiment of the third pattern in the third substrate 130 of FIG. 1. The view in FIG. 2B is in the negative z direction (z is pointing out of the page). The third pattern comprises one or more pillars 152. The embodiment of the third pattern shown in FIG. 2B is just a portion of the third pattern because pillars are repeated in the x and/or y dimensions.

In FIGS. 2A and 2B, pillars 152 and recesses 154 have a circular cross section in the x-y plane, which may be interlocked with one another to allow for alignment in the x-y plane, while ensuring a vertical alignment of the components (e.g., chips) based on the depth and/or height of the 3-dimensional patterns. Though the patterns are shown with circular shapes, patterns may include various geometric shapes (e.g., raised segments defining circular, elliptical, rectangular, polygonal, or free form cross-sections and associated recessed segments of similar cross sections). Different shapes of pillars and recesses can be mixed. For example, there can be triangular and circular pillars in the third substrate 130 so that certain chips (e.g., having circular recesses) cannot be placed in areas of the third substrate 130 (e.g., having pillars with triangular cross sections), so that certain components cannot be mistakenly placed in a wrong area on the third substrate 130.

Fabrication and etching techniques which may be used to form the patterns on the substrates may include both wet etching and dry etching techniques. The wet etching techniques may include isotropic wet etching and anisotropic wet etching. Isotropic wet etching allows for etching of a material uniformly in all directions. Chemicals such as hydrofluoric acid (HF), nitric acid (HNO₃), and acetic acid (CH₃COOH) may be used. Isotropic etching allows for an undercut around the mask, which may lead to rounded features, which might help with fitting. Anisotropic wet etching allows for etching of silicon at different rates in different crystallographic directions. This may allow for precise control over the shape and profile of an etched or formed feature. Potassium hydroxide (KOH) and tetramethylammonium hydroxide (TMAH) can be used etchants for anisotropic etching of silicon. Dry etching uses gases or plasmas to remove material from a silicon wafer. Dry etching can offer more control over the etching process compared to wet etching, in some embodiments, and can create more precise and/or smaller features. Plasma etching uses reactive ions and radicals to chemically interact with the silicon surface, typically resulting in isotropic etching patterns that can be adjusted to achieve slight anisotropy through plasma parameter modulation. Reactive Ion Etching (RIE) employs an electric field to accelerate plasma ions towards the substrate, incorporating a physical sputtering mechanism alongside chemical reactions to attain more anisotropic etching with precise, vertical sidewalls. Deep Reactive Ion Etching (DRIE), which, through a cyclic etching and passivation sequence, enables the formation of deep, high aspect ratio structures with vertical sidewalls. Inductively Coupled Plasma (ICP) Etching expands upon RIE by using an inductively coupled plasma source for enhanced plasma density and reduced pressure, leading to increased etching rates and improved control over etch profiles.

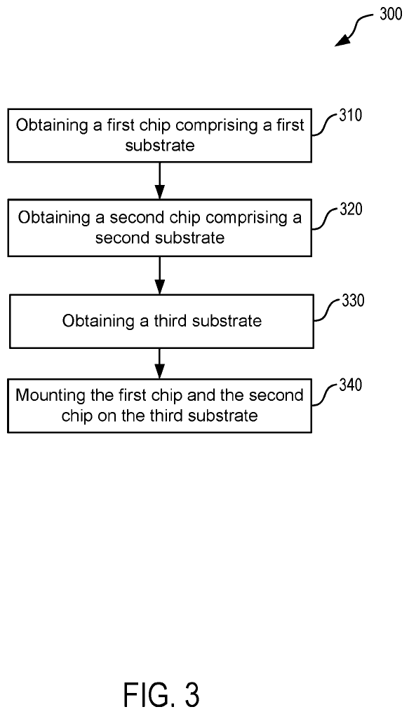

FIG. 3 illustrates a flowchart of an embodiment of a process 300 for aligning optical devices. Process 300 begins at step 310 with obtaining a first chip (e.g., the first chip 104 in FIG. 1). For example, the first chip can be formed by etching and bonding, or obtained from a vendor. The first chip comprises a first substrate that is coupled with a first optical device. A first pattern is formed within the first substrate.

At step 320 a second chip is obtained (e.g., the second chip 120 in FIG. 1). The second chip comprise a second substrate coupled with a second optical device. A second pattern is formed within the second substrate.

At step 330, a third substrate is obtained (e.g., the third substrate 130 in FIG. 1). The third substrate has a third pattern formed within the third substrate to complement the first pattern and the second pattern.

At step 340, the first chip and the second chip are mounted on the third substrate. The third pattern is arranged to complement the first pattern and the second pattern so that the first optical device is optically aligned with the second optical device while the first chip and the second chip are mounted on the third substrate. For example, the first optical device horizontally aligned (e.g., is butt coupled) with the second optical device.

In some embodiments, alignment is tested. Metrics related the alignment may be obtained through measurement. Metrics may include a decibel loss in a signal or other properties of light. These may include, for example, wavefront error, which evaluates phase distortions in the light wave; coupling efficiency, indicating the proportion of light successfully transferred between components; beam waist displacement, measuring deviations of the beam's focal point; and/or mode field diameter mismatch, assessing disparities in the mode field diameters between optical interfaces. Insertion loss may be comprehensively evaluated to determine the total loss introduced by the alignment.

Fiber to chip alignment, in some situations, uses a design constraint of sub 1 micron scale. In some embodiments (e.g., using Silicon Oxide mode converters), a multitude of different optical modes at an edge of the chip can be matched and −1 dB (20% deviation in coupling) tolerance of 2.5 microns has been achieved. This, in combination with the elastic averaging coupling scheme, can make PICs truly pluggable.

A pattern of the alignment structure on a Silicon (or other material) substrate used as an interposer for a laser chip or a fiber assembly, with a complementary alignment pattern on the backside, can be used. This allows for quick assembly of the photonic system and easy swapping of individual system components in case of failure. This enables the system truly pluggable and resilient to component failure, since a user can quickly replace a laser chip and/or fiber connection, which are the two common points of failure in an electro-optic system.

In some configurations, stubs (or posts) and/or the substrates for PICs and electronics can be metallized to allow for direct connection while performing alignment, leading to reduction or elimination of electronic wire bonding, flip chip bonding, etc. In some situations (e.g., when flip-chip bonding is not used) direct access to a top of a chip enables easy heat extraction. Using techniques described herein, consistent sub-micron alignment between chips can be achieved. Alignment structures can be used without mode-converter structures.

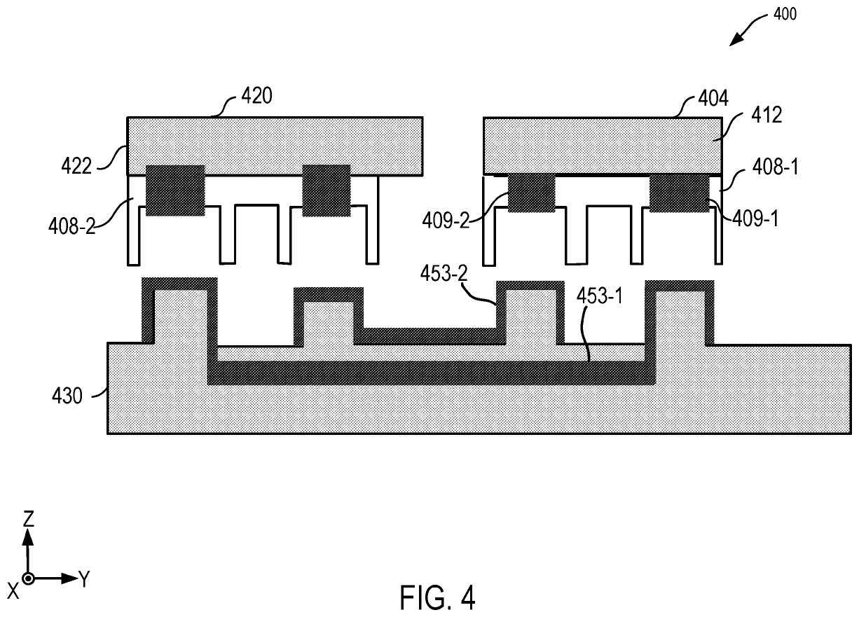

Referring to FIG. 4, an embodiment of a photonic system 400 for aligning photonic components is shown. The photonic system 400 comprises a first chip 404. The first chip 404 comprises a first substrate 408-1 and a first optical device 412 (e.g., an electronic ASIC or other electro-optics chip) coupled with the first substrate 408-1. A first electrical contact 409-1 and a second electrical contact 409-2 are formed on, across, or through the first substrate 408-1 to allow for electric connections to the first substrate 408-1 and/or the first optical device 412. Electrical contacts 409 are formed from electrically conductive material, such as a metallic material. Electrical contacts 409 allow for a connection to be formed between a third substrate 430 while the first chip 404 is situated on the third substrate 430.

Similarly, a second chip 420 comprises a second substrate 408-2 and a second optical device 422 coupled with the second substrate 408-2. A third electrical contact 409-3 and a fourth electrical contact 409-4 are formed through or across the second substrate 408-2 and/connected with the second optical device 422.

The photonic system 400 comprises the third substrate 430. A pattern is formed within the third substrate, which compliments patterns in the first substrate 408-1 and the second substrate 408-2, so that the first optical device 412 is optically aligned with the second optical device 422, while the first chip 404 and the second chip 420 are mounted on the third substrate 430 (e.g., similarly as described with FIG. 1).

A first conductive layer 453-1 is formed within, across, and/or on a surface of third substrate 430. A second conductive layer 454-2 is formed within, across, and/or on the surface of the third substrate 430. In some examples, the first conductive layer 453-1 is electrically connected with a positive terminal and the second conductive layer 453-2 is electrically connected with a negative terminal. For example, when the first chip 404 and second chip 420 are mounted on the third substrate 430 (e.g., an interposer), an electric circuit may be completed, allowing for the first optical device 412 and the second optical device 422 to be powered.

As it is possible to form an electrical connection when aligning the first optical device 412 and the second optical device 422 (e.g., while the first chip 404 and the second chip 420 are mounted on the third substrate), without electronic wire bonding or flip chip bonding, additional benefits can be obtained. For example, as the unbonded side of the second optical device 422 or the first optical device 404 may be used as a surface to extract heat and obtain improved performance characteristics for either optical device. As another example, the temperature of surfaces can be monitored to adjust the performance and/or extend longevity of components.

Similar to mounting chips on substrates, alignment structures can also be created in top and bottom of chips, which allows for sub-micron alignment of chips when stacking them on top of each other for electronic and/or optical signal transfer. This methodology can be used to stack multiple PICs or electronic chips or combinations of electro-optic devices.

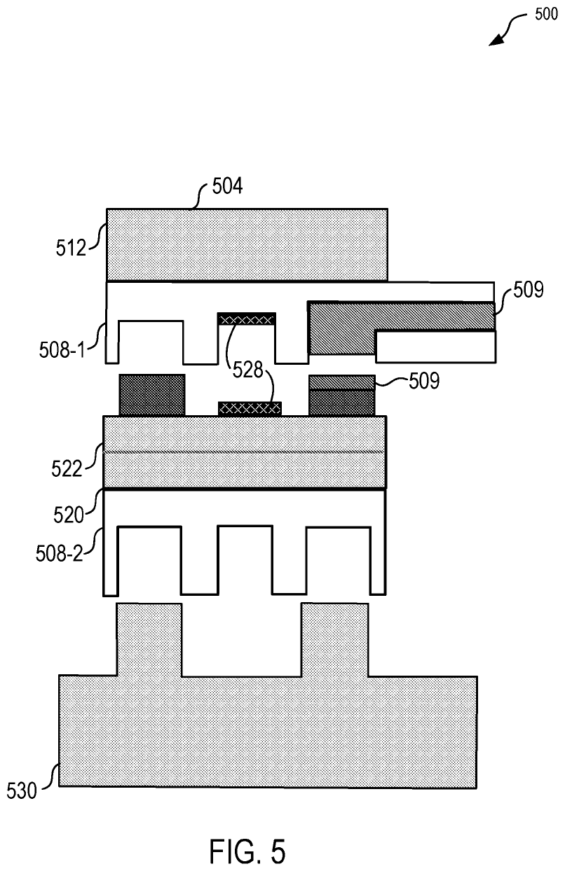

Referring to FIG. 5, an embodiment of a photonic system 500 for aligning photonic components is shown. Photonic system 500 illustrates a configuration to allow for a stack of multiple photonic integrated circuits (PICs), electronic chips, and/or other combination of electro-optical chips, while maintaining alignment between chips.

Illustrated in FIG. 5 is a first chip 504 comprising a first substrate 508-1 and a first optical device 512. The photonic system 500 comprises a second chip 520 comprising a second optical device 522 and a second substrate 508-2. The first optical device 512 and/or the second optical device 522 is a photonic integrated circuit, in some embodiments.

The first chip 504 and the second chip 520 comprise optical coupling structures 528 (e.g., gratings) to optically couple light between the first chip 504 and the second chip 520. Electrical connections 509 are formed within the first chip 504 and the second chip 520 as illustrated in FIG. 5.

FIG. 5 illustrates a third substrate 530 with a pattern. Similar to the description provided with respect to FIG. 1, the second chip 520 may be mounted or placed upon the third substrate 530 with the first chip 504 mounted to the second chip 520 (e.g., using complimentary patterns).

As illustrated in FIG. 5, the optical system 500 may be configured to allow the first chip 504 to be mounted in a first dimension (e.g., a z dimension) on to the second chip 522, and in turn, for the second chip 522 to be mounted on the third substrate 530. Thus, a vertical “stack” may be formed using interlocking patterns. Though only two chips are shown, more than two chips (e.g., 3, 4, 5, or more) are stacked on top of each other creating multiple layers. Vertical stacking shown in FIG. 5 can be combined with horizontal alignment, (e.g., shown in FIG. 1 and FIG. 4) to create three-dimensional integrated electrical and/or optical structures with multiple layers. In some configurations, one or more electrical connections are made from the first chip 504 to the third substrate 530 through the second chip 520 (e.g., using one or more through vias). Thus, the second chip 520 can have a device (e.g., a laser or PIC) and further function as an interposer for the first chip 504.

Though examples of chips in FIGS. 1-5 are shown and described with optical (e.g., electro-optical) components, similar techniques can be used to stack and/or horizontally align electronic chips. In another example, micro-optics (e.g., free space) can be aligned on substrates. In some variations, patterns for interlocking components are built into the components themselves.

Embodiments were chosen and described in order to explain the principles of the invention and practical applications to thereby enable others skilled in the art to best utilize the invention in various embodiments and with various modifications as are suited to the particular use contemplated. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc.

A recitation of “a”, “an”, or “the” is intended to mean “one or more” unless specifically indicated to the contrary.

All patents, patent applications, publications, and descriptions mentioned here are incorporated by reference in their entirety for all purposes. None is admitted to be prior art.

1. (canceled)

2. A system for aligning photonic devices comprising:
a first chip comprising a first substrate coupled with a first optical device, a first pattern formed within the first substrate, wherein the first pattern is a three-dimensional pattern;
a second chip comprising a second substrate coupled with a second optical device, a second pattern formed within the second substrate, wherein the second pattern is a three-dimensional pattern; and
a third substrate, a third pattern formed within the third substrate, wherein the third pattern is a three-dimensional pattern and arranged to complement the first pattern and the second pattern so that the first optical device is optically aligned with the second optical device while the first chip and the second chip are mounted on the third substrate.

3. The system of claim 2, wherein the first pattern and the second pattern are configured to interlock with the third pattern.

4. The system of claim 2, wherein the first substrate, the second substrate, and the third substrate are formed from silicon.

5. The system of claim 2, wherein an alignment of the first optical device and the first optical device is in a dimension orthogonal to a height of the third substrate so that the first optical device is butt coupled with the second optical device.

6. (canceled)

7. The system of claim 2, wherein the first chip, the second chip, and the third substrate contain alignment structures that are substantially perpendicular to a direction of light propagation.

8. (canceled)

9. The system of claim 2, wherein the first substrate is non-contiguous with the second substrate while mounted on the third substrate.

10. The system of claim 2, wherein:
the first optical device is a laser, and
the second optical device comprises an fiber assembly or a semiconductor waveguide.

11. The system of claim 2, wherein the second pattern is the same as the first pattern.

12. The system of claim 10, wherein the waveguide comprises a nitride taper formed within the waveguide.

13. A method for aligning photonic devices comprising:
obtaining a first chip, wherein the first chip comprises a first substrate coupled with a first optical device, a first pattern formed within the first substrate, wherein the first pattern is a three-dimensional pattern;
obtaining a second chip, wherein the second chip comprises a second substrate coupled with a second optical device, a second pattern formed within the second substrate, wherein the second pattern is a three-dimensional pattern;
obtaining a third substrate, a third pattern formed within the third substrate, wherein the third pattern is a three-dimensional pattern; and
mounting the first chip and the second chip on the third substrate, wherein the third pattern is arranged to complement the first pattern and the second pattern so that the first optical device is optically aligned with the second optical device while the first chip and the second chip are mounted on the third substrate.

14. The method of claim 13, further comprising measuring an optical alignment between the first optical device and the second optical device.

15. The method of claim 14, further comprising modifying an etching of the first substrate, the second substrate, and/or the third substrate based on the optical alignment measured.

16. The method of claim 13, wherein the first pattern and the second pattern are configured to interlock with the third pattern.

17. The method of claim 13, wherein:
an alignment of the first optical device and the second optical device is in a dimension substantially perpendicular with a height of the third substrate; and
the first substrate, the second substrate, and the third substrate contain alignment structures which are substantially parallel to the height of the third substrate.

18. (canceled)

19. The method of claim 13, wherein the first substrate is non-contiguous with the second substrate while mounted on the third substrate.

20. (canceled)

21. A system comprising:
a first chip comprising a first device, a first pattern formed within the first chip;
a second chip comprising a second device, a second pattern formed within the second chip; and
a substrate, a third pattern formed within the substrate, wherein:
the third pattern is arranged to complement the first pattern and/or the second pattern; and
the first device is aligned with the second device.

22. The system of claim 21, further comprising:
an electrical contact in the first pattern of the first chip; and
a conductive layer in the substrate in the third pattern, arranged to electrically connect with the electrical contact in the first pattern while the first chip is mounted to the substrate.

23. The system of claim 22, wherein:
the electrical contact is in a recess of the first pattern; and
the conductive layer is on a post of the third pattern.

24. The system of claim 21, wherein:
the first chip is optically aligned horizontally with the second chip; and
vertical is defined in a direction of a height of the substrate.

25. (canceled)

26. The system of claim 21, wherein:
the first chip mounted on top of the second chip;
the second chip is mounted on the substrate, so that the second chip is between the substrate and the first chip while the second chip is mounted on the substrate;
the first chip is optically aligned vertically with the second chip; and
vertical is in a direction of a height of the substrate.

27. (canceled)
